(19) United States
(12) Patent Application Publication
(10) Pub. No.: US 2014/0204027 A1
(43) Pub. Date: Jul. 24, 2014

(54) SMART BEZEL ICONS FOR TABLETS

(71) Applicant: DELL PRODUCTS L.P., Round Rock, TX (US)

(72) Inventors: Erin K. Walline, Pflugerville, TX (US); James H. Hallar, Austin, TX (US); Aaron vom Eigen, Austin, TX (US); Adrian Taylor, Austin, TX (US)

(73) Assignee: DELL PRODUCTS L.P., Round Rock, TX (US)

(21) Appl. No.: 13/747,839

(22) Filed: Jan. 23, 2013

(51) Int. Cl. G06F 3/0346

(52) U.S. Cl. CPC G06F 3/0346
USPC 345/158

(57) ABSTRACT

A system, method, and computer-readable medium are disclosed for facilitating user interaction with a mobile device. A first control function is associated with a first user control located in a first location on the bezel of a mobile device to establish a target operational position for any user control that is subsequently associated with the control function. When the orientation of the mobile device is changed, the first control function is associated with a second user control, located in a second location on the bezel, to maintain the target operational position of the user control associated with the control function.

### BACKGROUND OF THE INVENTION

1. Field of the Invention

The present invention relates to the management of information handling systems. More specifically, embodiments of the invention provide a system, method, and computer-readable medium for facilitating user interaction with a mobile device.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One class of information handling systems are mobile devices such as cell phones, portable digital assistants (PDAs), convertible laptop devices, and tablet computers, all of which have become popular in recent years for communicating, processing and displaying a wide variety of data. Such mobile devices are typically used in one of two orientations for different applications. For example, a tablet computer is typically used in a horizontal, or “landscape,” orientation to make viewing movies and pictures a more pleasant experience, while a vertical, or “portrait,” orientation is generally better suited for browsing the Internet or reading digital books.

Determining the orientation of a mobile device is usually accomplished through the use of small motion sensors known as accelerometers. As the user rotates the mobile device from one orientation to another, the accelerometers detect the change and cause the device's operating system and software to respond by adjusting the display to match the new orientation. Typically, text, images and video displayed within the mobile device's display are rotated as well.

However, a mobile device's user controls are typically located in one or more fixed position on its bezel. As a result, the operational location of the user control, relative to the user, changes as the orientation of the mobile device is changed. For example, if a tablet computer's “home button” is located on the short axis of its bezel, then it is typically centered at the bottom when the tablet is in portrait mode. However, if the orientation of the tablet is changed to landscape mode, then the “home button will be centered either on the right or left side of the tablet. As a result, a user may experience inconvenience or confusion in locating the user control when the orientation of the tablet is changed, particularly when the user control is not significantly physically differentiated from the surrounding surface.

### SUMMARY OF THE INVENTION

A system, method, and computer-readable medium are disclosed for facilitating user interaction with a mobile device. In various embodiments, one or more user controls are implemented on each side of a mobile device's bezel. In one embodiment, a first control function is associated with a first user control located in a first location on the bezel of a mobile device to establish a target operational position for any user control that is subsequently associated with the control function. When the orientation of the mobile device is changed, such as from “landscape” to “portrait,” the first control function is associated with a second user control, located in a second location on the bezel, to maintain the target operational position.

In one embodiment, the first control function is concurrently associated with the first and second user controls as the orientation of the mobile device is being changed. In one embodiment, the first user control is no longer associated with the control function once the orientation of the mobile device has been changed and the first control function is associated with the second user control. In one embodiment, a second control function is associated with a third user control located in a third location on the bezel of the mobile device to establish a second target operational position. When the orientation of the mobile device is changed, the second control function is associated with a fourth user control, located in a fourth location on the bezel, to maintain the target operational position.

In one embodiment, the bezel of the mobile device includes one or more backlit icons to respectively indicate the association of the first and second control functions to the first or second, and third or fourth user controls. In one embodiment, the first, second, third and fourth user controls may comprise one or more mechanical, touch-sensitive, vibro-tactile, or proximity switches.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIGS. 1A-B (labeled prior art) show a mobile device that includes a user control located in a fixed location on its bezel;

FIG. 2 is a general illustration of components of an information handling system as implemented in the system and method of the present invention;

FIG. 3 shows a mobile device that includes a user control located in a predetermined location on each side of its bezel;

FIGS. 4A-F show the association of an individual control function with a plurality of individual user controls; and

FIGS. 5A-B show the association of a plurality of control functions with a plurality of individual user controls.

### DETAILED DESCRIPTION

A system, method, and computer-readable medium are disclosed for facilitating user interaction with a mobile device. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

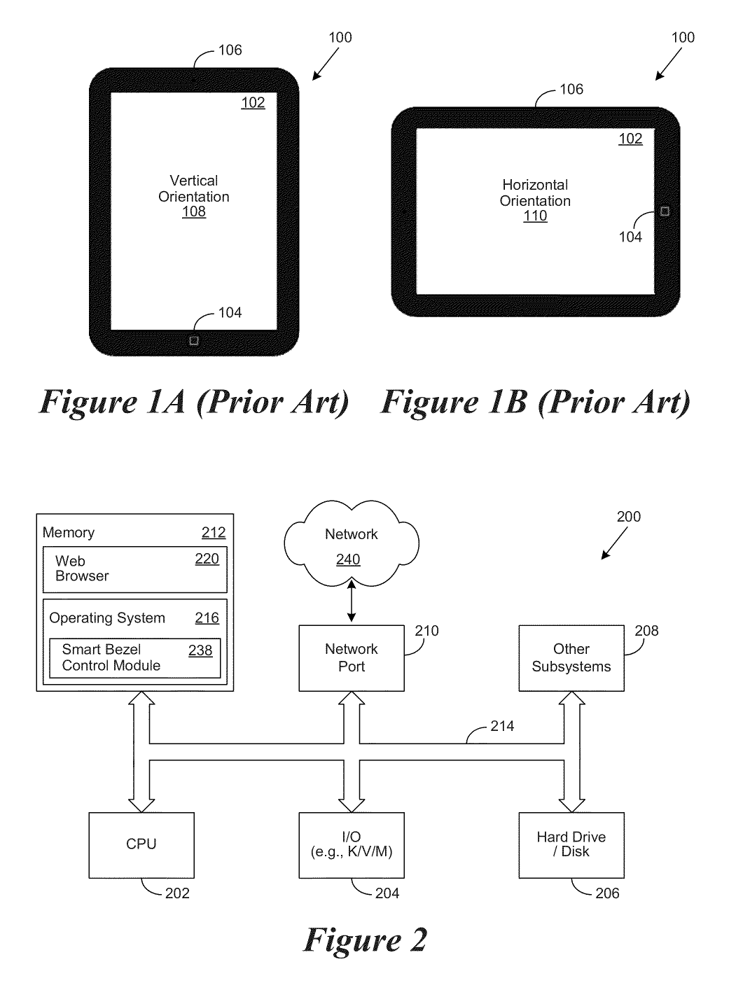

FIGS. 1A-B (labeled prior art) show a mobile device 100 that includes a display 102 and a user control 104 located in a fixed location on its bezel 106. As used herein, a user control 104 refers to any control mechanism operable to be used by a user to interact with the mobile device 100. In various embodiments, the user control 104 may include a mechanical, touch-sensitive, vibro-tactile, or proximity switch. In certain embodiments, the user control may be associated with a fixed-image icon, a variable-image icon, or a backlit icon.

In various embodiments, a predetermined control operation is perpetually associated with the user control 104. As used herein, a control operation broadly refers to any operation that initiates or affects the receiving, storing, processing, interpretation, transmission, provision or display of data. As an example, a “home button” control operation may be associated with the user control 104. In this example, actuation of the user control 104 by a user may result in the “home button” control function displaying a menu of application icons within the display 102.

Skilled practitioners of the art will recognize that the fixed location of the user control 104 on the bezel 106 limits its ability to maintain a consistent operational position relative to a user of the mobile device 100. As used herein, operational position, in general, refers to the position of the user control 104, relative to the orientation of the mobile device 100, from the perspective of a user. For example, as shown in FIG. 1A, the operational position of the user control 104 may be at the bottom of the mobile device 100 when it is in a vertical orientation 108.

However, as shown in FIG. 1B, its operational position may be at the right side of the mobile device 100 when it is in a horizontal orientation 110. Likewise, the fixed location of the use control 104 may result in it being respectively located at the top or the left of the mobile device 100 when it is placed in a vertical orientation 108 or horizontal orientation 110. As a result, the operational position of the user control 104 is not consistent when the orientation of the mobile device 100 is changed. Due to this inconsistency, a user may experience inconvenience or confusion in locating the user control 104 when the orientation of the mobile device 100 is changed.

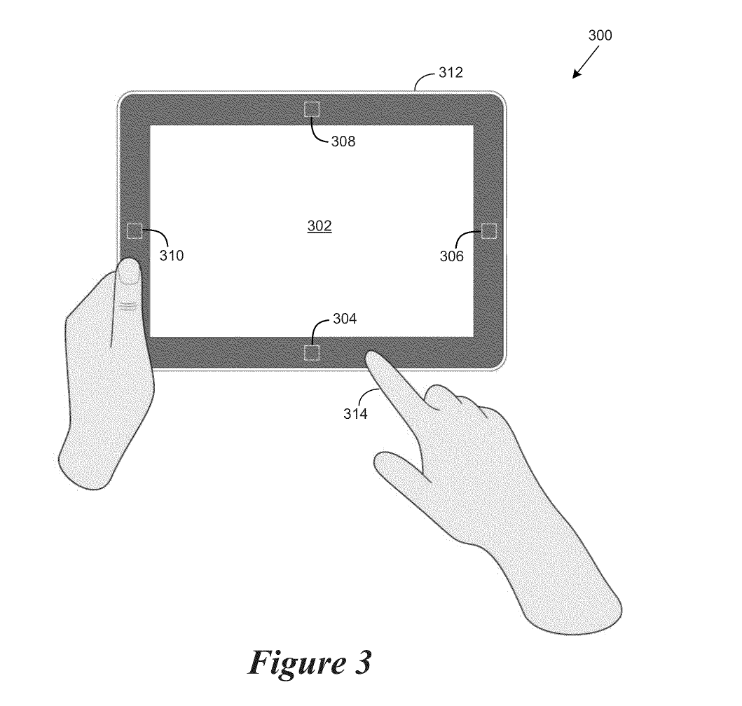

FIG. 2 is a generalized illustration of an information handling system 200 that can be used to implement the system and method of the present invention. The information handling system 200 includes a processor (e.g., central processor unit or “CPU”) 202, input/output (I/O) devices 204, such as a display, a keyboard, a mouse, and associated controllers, a hard drive or disk storage 206, and various other subsystems 208. In various embodiments, the information handling system 200 also includes a network port 210 operable to connect to a network 240. The information handling system 200 likewise includes system memory 212, which is interconnected to the foregoing via one or more buses 214. System memory 212 further includes operating system (OS) 216 and may also include a web browser 220 in various embodiments. In at least one embodiment, the OS 216 includes a smart bezel control module 238.

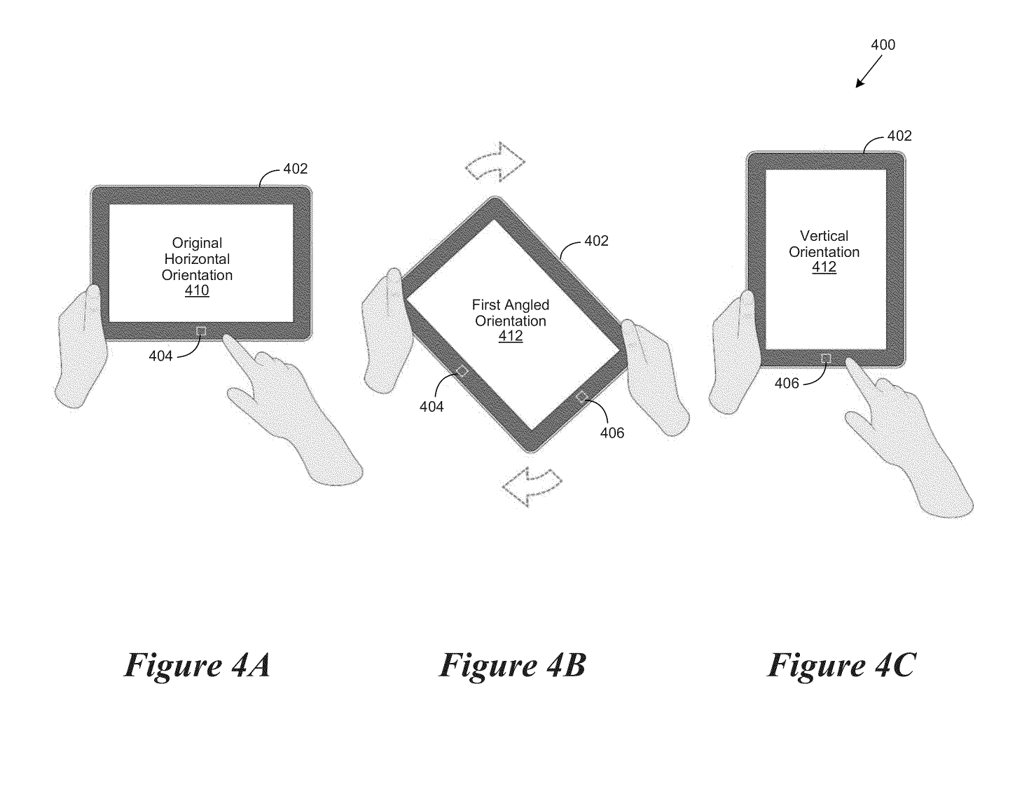

FIG. 3 shows a mobile device 300 that includes a display 302 and a user control located in a predetermined location on each side of its bezel 312 in accordance with an embodiment of the invention. As shown in FIG. 3, user controls 304, 306, 308, 310 are respectively located in a predetermined location on the bottom, right-hand, top and left-hand sides of the bezel 312. The predetermined locations of the user controls 304, 306, 308, 310 are a matter of design choice. In this embodiment a predetermined control function is associated with the user controls 304, 306, 308, 310 according to the orientation of the mobile device 300.

As an example, a “home button” control function that displays a menu of application icons within the display 302 may be associated with user control 304. In this example, the “home button” control function is initiated in response to a user gesture, such as a user actuating user control 304 with a touch of their fingertip 314. As another example, control functions for paging through a digital book may be associated with user controls 306 and 310. To further the example, user controls 306 and 310 may respectively display the next, or the previous, page in the digital book when actuated by a user gesture. In yet another example, a control function that monitors and displays the current status of wireless connectivity for the mobile device 300 may be associated with user control 308. In this example, the current wireless connectivity status of the mobile device 300 is displayed within the display 302 when user control 308 is actuated by a user gesture.

In one embodiment, a predetermined control function is associated with only one of the user controls 304, 306, 308 or 310 according to the current orientation of the mobile device 300. As an example, it may be desirable to only initiate a “home button” control function from a user control that is operationally positioned on the bottom side of the bezel 312. In this example, the “home button” control function would be associated with user control 304 when the mobile device 300 is in a horizontal orientation. However, if the mobile device was rotated to the right such that it was in a vertical orientation, then the “home button” control function would be associated with user control 306.

In one embodiment, two or more predetermined control functions are selectively associated with the user controls 304, 306, 308, 310 according to the orientation of the mobile device 300. For example, it may be desirable to respectively initiate “display previous page” and “display next page” control functions from user controls that are operationally positioned on the left-hand and right-hand sides of bezel 312 regardless of the orientation of the mobile device 300. In this example, the “display previous page” control function would be associated with user control 310 and the “display next page” control function would be associated with user control 306 when the mobile device 300 is in a horizontal orientation. However, if the mobile device was rotated to the right such that it was in a vertical orientation, then the “display previous page” control function would be associated with user control 304 and the “display next page” control function would be associated with user control 308.

In various embodiments, the current association of a control function with its associated user control 304, 306, 308, 310 is indicated by a corresponding backlit icon. In various embodiments, backlit icons corresponding to user controls 304, 306, 308, 310 that are not currently associated with a control function are not illuminated. In certain embodiments, one or more backlit icons are configurable to display an image related to a control function's associated user control. In various embodiments, the user controls 304, 306, 308, 310 may include one or more mechanical, touch-sensitive, or proximity switches. In certain embodiments, the bezel 312 is touch-sensitive and the user controls 304, 306, 308, 310 are defined as predetermined areas of the touch-sensitive bezel 312. In these embodiments, the defined areas are configured to operate as touch-sensitive user controls that can be associated with a predetermined control function.

In certain embodiments, any side of the bezel 312 may include more than one user control 304, 306, 308, 310. As an example, one side of the bezel 312 may include two user controls respectively associated with “scroll up” and “scroll down” control functions. In certain embodiments, any side of the bezel may not include a user control 304, 306, 308, 310. In various embodiments, the orientation of the mobile device 300 is determined through the use of one or more accelerometers familiar to those of skill in the art.

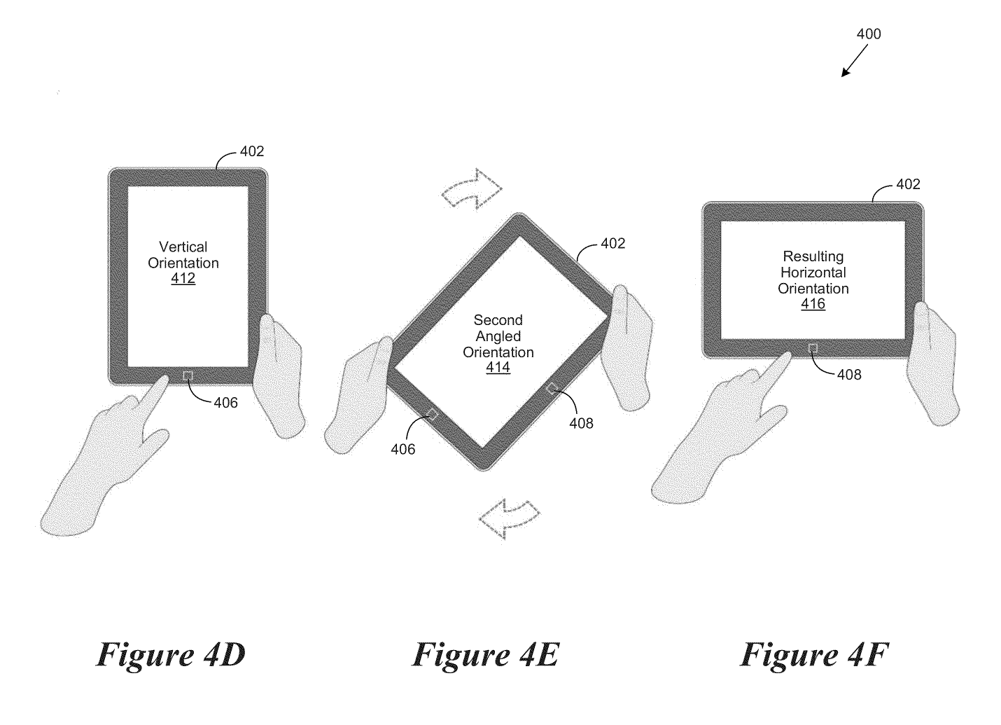

FIGS. 4A-F show the association of an individual control function with a plurality of individual user controls in accordance with an embodiment of the invention. In this embodiment, an individual control function is selectively associated with user controls 404, 406, and 408 as the orientation of the mobile device 400 is changed. As an example, it may be desirable that a “home button” control function be initiated from a user control whose operational position is consistently maintained on the bottom side of the bezel 402 regardless of the orientation of the mobile device 400.

As shown in FIG. 4A, a “home button” control function is associated with user control 404 when the mobile device 400 is in an original horizontal orientation 410. As likewise shown in FIG. 4A, a backlit icon corresponding to the “home button” control function is illuminated to indicate its association with user control 404. Then, as shown in FIG. 4B, the mobile device 400 is rotated to a first angled orientation 412. As the mobile device 400 is rotated, the “home button” control function is concurrently associated with user control 406, which was originally operationally positioned on the right-hand side of the bezel 402. As likewise shown in FIG. 4B, a backlit icon associated with “home button” control function is illuminated to indicate its concurrent association with user control 406.

As the mobile device 400 is further rotated to a vertical orientation 412, the “home button” control function continues to be associated with user control 406. However, as shown in FIG. 4C, the “home button” control function is no longer associated with user control 404 once the mobile device 400 attains a vertical orientation 412. As likewise shown in FIG. 4C, the backlit icon associated with the “home button” control function continues to be illuminated to indicate its association with user control 406. However, the backlit icon that previously indicated its concurrent association with user control 404 ceases to be illuminated, which indicates it is no longer associated with the “home button” control function.

As shown in FIG. 4D, the “home button” control function is solely associated with user control 406, which is now operationally positioned on the bottom side of the bezel 402. Then, as shown in FIG. 4E, the mobile device 400 is rotated to a second angled orientation 414. As the mobile device 400 is rotated, the “home button” control function is concurrently associated with user control 408, which was originally operationally positioned on the top side of the bezel 402. As likewise shown in FIG. 4e, a backlit icon associated with the “home button” control function is illuminated to indicate its association with user control 408.

As the mobile device 400 is further rotated to a resulting horizontal orientation 412, the “home button” control function continues to be associated with user control 408. As shown in FIG. 4F, the backlit icon associated with the “home button” control function continues to be illuminated to indicate its association with user control 408. However, the backlit icon that previously indicated its concurrent association with user control 406 ceases to be illuminated, which indicates it is no longer associated with the “home button” control function. From the foregoing, skilled practitioners of the art will recognize that an individual control function can be selectively associated with user controls 404, 406 and 408 to maintain their operational position relative to the user as the mobile device 400 is rotated.

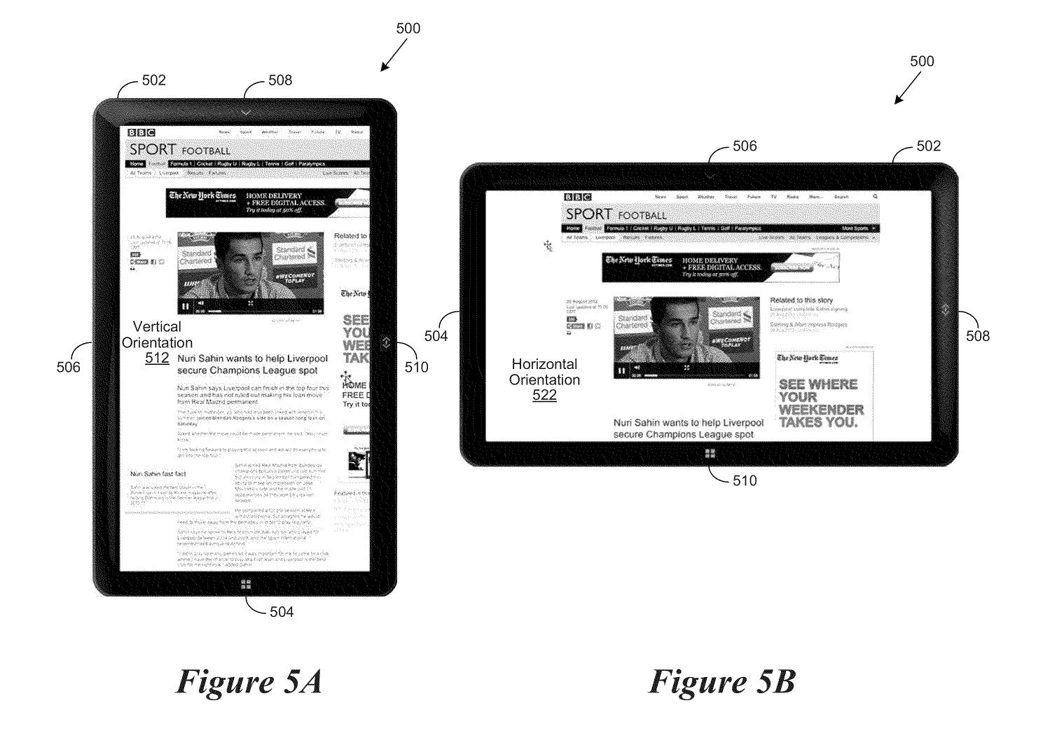

FIGS. 5A-B show the association of a plurality of control functions with a plurality of individual user controls in accordance with an embodiment of the invention. In this embodiment, the association of a plurality of control functions with user controls 504, 506, 508, and 510 is changed in response to a corresponding change in the orientation of a mobile device 500. As an example, it may be desirable that a “home button” control function be initiated from a user control whose operational position is consistently maintained on the bottom side of the bezel 502 regardless of the orientation of the mobile device 500. Likewise, it may be desirable to initiate “scroll page,” and “display wireless connectivity status” control functions from user controls whose operational positions are respectively maintained on the right-hand and top sides of the bezel 502.

As shown in FIG. 5A, when the mobile device 500 is in a vertical orientation 512, “home button,” “scroll page,” and “display wireless connectivity status” control functions are respectively associated with user controls 504, 510 and 508. As likewise shown in FIG. 5A, the association of each of the control functions with their respective user controls 504, 510 and 508 is indicated with a corresponding backlit icon. However, since no control function is associated with user control 506, its corresponding backlit icon is not illuminated.

As shown in FIG. 5B, the original association of the “home button” control function with user control 504 shown in FIG. 5A is changed to an association with user control 510 when the mobile device 500 is placed in a horizontal orientation 522. Likewise, the backlit icon associated with “home button” control function is now illuminated to indicate its association with user control 510. As likewise shown in FIG. 5B, the original association of the “scroll page” and “display wireless connectivity status” control functions with user controls 510 and 508 shown in FIG. 5A are respectively changed to associations with user controls 508 and 506. Likewise, the backlit icons associated with the “scroll page” and “display wireless connectivity status” control functions are now illuminated to indicate their association with user controls 508 and 506.

In one embodiment, the vertical orientation 512 and the horizontal orientation 522 of the mobile device 500 is determined through the implementation of one or more accelerometers familiar to those of skill in the art. From the foregoing, skilled practitioners of the art will recognize that a plurality of user controls can be selectively associated with a corresponding plurality of control functions to maintain their operational position as the orientation of a mobile device is changed.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A computer-implementable method for facilitating user interaction with a mobile device, comprising:
associating a first control function with a first, user control located in a first location on the bezel of a mobile device, the first location comprising a first target operational position;
changing the orientation of the mobile device; and
associating the first control function with a second user control located in a second location on the bezel of the mobile device, the second location maintaining the first target operational position once the orientation of the mobile device is changed.

2. The method of claim 1, wherein the first control function is concurrently associated with the first user control and the second user control as the orientation of the mobile device is being changed.

3. The method of claim 1, wherein the first control function is no longer associated with the first user control when once the orientation of the mobile device has been changed and the first control function is associated with the second user control.

4. The method of claim 1, further comprising:
associating a second control function with a third user control located in a third location on the bezel of the mobile device, the third location comprising a second target operational position;
changing the orientation of the mobile device; and
associating the second control function with a fourth user control located in a fourth location on the bezel of the mobile device, the fourth location maintaining the second target operational position once the orientation of the mobile device is changed.

5. The method of claim 4, wherein the bezel of the mobile device comprises a backlit icon that is illuminated to indicate at least one of the set of:
the association of the first control function with the first user control;
the association of the first control function with the second user control;
the association of the second control function with the third user control; and
the association of the second control function with the fourth user control.

6. The method of claim 5, wherein the first, second, third and fourth user controls comprise at least one of the set of:
a mechanical switch;
a touch-sensitive switch; and
a proximity switch.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations to facilitate user interaction with a mobile device and comprising instructions executable by the processor and configured for:
associating a first control function with a first user control located in a first location on the bezel of a mobile device, the first location comprising a first target operational position;
changing the orientation of the mobile device; and
associating the first control function with a second user control located in a second location on the bezel of the mobile device, the second location maintaining the first target operational position once the orientation of the mobile device is changed.

8. The system of claim 7, wherein the first control function is concurrently associated with the first user control and the second user control as the orientation of the mobile device is being changed.

9. The system of claim 7, wherein the first control function is no longer associated with the first user control when once the orientation of the mobile device has been changed and the first control function is associated with the second user control.

10. The system of claim 7, further comprising:
associating a second control function with a third user control located in a third location on the bezel of the mobile device, the third location comprising a second target operational position;
changing the orientation of the mobile device; and
associating the second control function with a fourth user control located in a fourth location on the bezel of the mobile device, the fourth location maintaining the second target operational position once the orientation of the mobile device is changed.

11. The system of claim 10, wherein the bezel of the mobile device comprises a backlit icon that is illuminated to indicate at least one of the set of:
the association of the first control function with the first user control;
the association of the first control function with the second user control;
the association of the second control function with the third user control; and
the association of the second control function with the fourth user control.

12. The system of claim 10, wherein the first, second, third and fourth user controls comprise at least one of the set of
a mechanical switch;
a touch-sensitive switch;
a vibro-tactile switch; and
a proximity switch.

13. A non-transitory, computer-readable storage medium embodying computer program code, the computer program code comprising computer executable instructions configured for:
associating a first control function with a first user control located in a first location on the bezel of a mobile device, the first location comprising a first target operational position;
changing the orientation of the mobile device; and
associating the first control function with a second user control located in a second location on the bezel of the mobile device, the second location maintaining the first target operational position once the orientation of the mobile device is changed.

14. The non-transitory, computer-readable storage medium of claim 13, wherein the first control function is concurrently associated with the first user control and the second user control as the orientation of the mobile device is being changed.

15. The non-transitory, computer-readable storage medium of claim 13, wherein the first control function is no longer associated with the first user control when once the orientation of the mobile device has been changed and the first control function is associated with the second user control.

16. The non-transitory, computer-readable storage medium of claim 13, further comprising:
associating a second control function with a third user control located in a third location on the bezel of the mobile device, the third location comprising a second target operational position;
changing the orientation of the mobile device; and
associating the second control function with a fourth user control located in a fourth location on the bezel of the mobile device, the fourth location maintaining the second target operational position once the orientation of the mobile device is changed.

17. The non-transitory, computer-readable storage medium of claim 16, wherein the bezel of the mobile device comprises a backlit icon that is illuminated to indicate at least one of the set of:
the association of the first control function with the first user control;
the association of the first control function with the second user control;
the association of the second control function with the third user control; and
the association of the second control function with the fourth user control.

18. The non-transitory, computer-readable storage medium of claim 17, wherein the first, second, third and fourth user controls comprise at least one of the set of:
a mechanical switch;
a touch-sensitive switch;
a vibro-tactile switch; and
a proximity switch.
